(19) United States
(12) Patent Application Publication
(10) Pub. No.: US 2022/0058668 A1
(43) Pub. Date: Feb. 24, 2022

(54) ADAPTIVE FORECASTING MODELS

(71) Applicant: eBay Inc., San Jose, CA (US)

(72) Inventors: Hanzhang WANG, San Jose, CA (US); Yitong GENG, Shanghai (CN); Huai JIANG, Shanghai (CN); Zhanxiang ZHAO, Shanghai (CN); Liangfei SU, Shanghai (CN)

(21) Appl. No.: 16/997,275

(22) Filed: Aug. 19, 2020

(51) Int. Cl. G06Q 30/02; G06Q 10/04

(52) U.S. Cl. CPC G06Q 30/0202; G06F 17/18; G06Q 10/04

(57) ABSTRACT

Technologies are disclosed for implementing a time series forecasting model. A time series forecasting model comprising a periodic component is modified to include an event-based component comprising a long-term portion representing impacts greater than one period of the periodic component, and a short-term portion representing impacts shorter than one period of the periodic component. A forecast is output using the modified time series forecasting model.

### BACKGROUND

Time series forecasting models are used to analyze time series data to harvest meaningful statistics as well as to predict future values based on previously observed values. For example, time series forecasting models may be used for forecasting the weather, stock prices, and various metrics for businesses. For many online entities, time series forecasting models can be used for user behavior analysis, sales forecasting, product and inventory planning, and item recommendations. It is with respect to these and other technical considerations that the disclosure made herein is presented.

### SUMMARY

Sudden spikes and other anomalies in a time series can be problematic for time series forecasting models. Various widespread events, such as a worldwide pandemic, or a sudden shift such as the annual change to daylight savings time, may introduce significant changes in behaviors than can invalidate the assumptions used in the models and thus produce inaccurate predictions.

Historical approaches to handling such sudden events have not produced useful results. Historical approaches either ignore the sudden event, or simply shift metrics and performance data to account for the sudden change. These approaches do not work well because humans react to such sudden events in different ways and over different time spans. For example, some people will adapt to the event immediately, and other people will adjust their behavior days or weeks later.

The disclosed technologies address the technical problems presented above, and potentially others, by providing an adaptive time series forecasting model that models such sudden events and allows the forecasting model to continue producing accurate results. An accurate and adaptive model allows for more accurate forecasting during such events, which in turn can enable, for example, more cost-efficient product management and improved sales. An accurate model can further enhance the functionality and efficiency of the time series forecasting model and related applications. For example, by reducing the amount of processing required to adapt the model to accurately handle sudden events, the utilization of computing resources can be improved. In addition, by adding an event-based component as described herein to time series models, such efficiencies can be realized in a variety of forecasting and planning scenarios.

Conventional time series forecasting models have two basic components. A trend component models the basic trend of a metric over time. A periodic or seasonal component models predictable changes based on the natural period of the metric (e.g., annual holiday sales). Some models may also include a noise component that accounts for expected variations in the data.

The disclosed embodiments add an event-based component that represents effects due to the impact of a sudden event including an initial impact and longer effects over an impact time period. More accurate forecasting based on the event-based component can allow for more effective responses to sudden events, such as inventory management, targeted advertising, commodity sales forecasts, anomaly detection, risk control, cyber security, item recommendations, and sales trend predictions. The event-based component can be used generally for various types of sudden events such as daylight savings time, leap year addition of a day in February, release of a set of coupons that is expected to boost business metrics, and unexpected natural events such as an earthquake or a pandemic.

The disclosed technologies allow for reduction of the amount of undue revising, reprogramming, and re-running of the models, thus reducing the waste of computing resources (e.g., amount of memory or number of processor cycles required to re-run models). Other technical benefits not specifically mentioned herein can also be realized through implementations of the disclosed technologies.

It should be appreciated that the subject matter described above and in further detail below can be implemented as a computer-controlled apparatus, a computer-implemented method, a computing device, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1 is an example user interface diagram showing aspects of an illustrative user interface disclosed herein for viewing the results of a forecasting model using the technologies disclosed herein;

FIG. 2 is a diagram showing aspects of an illustrative user interface disclosed herein for a forecasting model using the technologies disclosed herein;

FIG. 3 is an example computing system architecture diagrams showing aspects of a system disclosed herein for forecasting, according to one embodiment disclosed herein;

FIG. 4 is an example computing system architecture diagrams showing aspects of a system disclosed herein for forecasting, according to one embodiment disclosed herein;

FIG. 5 is an example flow diagram showing aspects of an illustrative routine for forecasting, according to one embodiment disclosed herein;

FIG. 6 is an example flow diagram showing aspects of an illustrative routine for forecasting, according to one embodiment disclosed herein;

FIG. 7 is a computer architecture diagram illustrating aspects of an example computer architecture for a computer capable of executing the software components described herein.

FIG. 8 is a data architecture diagram showing an illustrative example of a computer environment.

### DETAILED DESCRIPTION

The following Detailed Description presents technologies for an adaptive time series forecasting model that models sudden events and allows the forecasting model to continue producing accurate results. As discussed briefly above, and in greater detail below, the disclosed technologies can enable more accurate forecasting during such events, which in turn can enable, for example, more cost-efficient product management and improved sales. An accurate model can further enhance the functionality and efficiency of the time series forecasting model and related applications. For example, by reducing the amount of processing required to adapt the model to accurately handle sudden events, the utilization of computing resources can be improved. In addition, by adding an event-based component as described herein to time series models, such efficiencies can be realized in a variety of forecasting and planning scenarios. Technical benefits other than those specifically mentioned herein might also be realized through implementations of the disclosed technologies.

It is to be appreciated that while the technologies disclosed herein are primarily described in the context of electronic commerce systems, the technologies described herein can be utilized to provide an adaptive time series forecasting model in other configurations, which will be apparent to those of skill in the art. For example, the described techniques can be used in the updating of stock price information.

Referring now to the appended drawings, in which like numerals represent like elements throughout the several figures., aspects of various technologies for will be described. In the following detailed description, references are made to the accompanying drawings that form a part hereof, and which are shown by way of illustration specific configurations or examples.

In the example of an electronic commerce system, time series forecasting models may be used to analyze time series data to harvest meaningful statistics as well as to predict future values based on previously observed values. For example, time series forecasting models may be used for forecasting the weather, stock prices, and various metrics for businesses. For electronic commerce systems, time series forecasting models can be used for user behavior analysis, sales forecasting, product and inventory planning, and item recommendations.

Sudden spikes and other anomalies in a time series can be problematic for such models. Various widespread events, such as a worldwide pandemic, or a sudden shift such as the annual change to daylight savings time, may introduce significant changes in behaviors than can invalidate the assumptions used in the models and thus produce inaccurate predictions.

Historical approaches to handling such sudden events have not produced useful results. Historical approaches either ignore the sudden event, or simply shift metrics and performance data to account for the sudden change. These approaches do not work well because humans react to such sudden events in different ways and over different time spans. For example, some people will adapt to the event immediately, and other people will adjust their behavior days or weeks later.

Various embodiments disclosed herein provide an adaptive time series forecasting model that models such sudden events and allows the forecasting model to continue producing accurate results. An accurate and adaptive model allows for more accurate forecasting during such events, which in turn can enable more cost-efficient product management and improved sales. An accurate model can further enhance the functionality and efficiency of the time series forecasting model and related applications. For example, by reducing the amount of processing required to adapt the model to accurately handle sudden events, the utilization of computing resources can be improved. In addition, by adding an event-based component as described herein to time series models, such efficiencies can be realized in a variety of forecasting and planning scenarios.

Conventional time series forecasting models typically have two basic components. A trend component models the basic trend of a metric over time. A periodic or seasonal component models predictable changes based on the natural period of the metric (e.g., annual holiday sales). Some models may also include a noise component that accounts for expected variations in the data.

In an embodiment, an event-based component may be added that represents effects due to the impact of a sudden event including an initial impact and longer effects over an impact time period. More accurate forecasting based on the event-based component can allow for more effective responses to sudden events, such as inventory management, targeted advertising, commodity sales forecasts, anomaly detection, risk control, cyber security, item recommendations, and sales trend predictions. The event-based component can be used generally for various types of sudden events such as daylight savings time, leap year addition of a day in February, release of a set of coupons that is expected to boost business metrics, and unexpected natural events such as an earthquake or a pandemic.

In an embodiment, an event-based time series forecasting model may be represented by:

TSₜ=Tₜ+Sₜ+Eₜ+Nₜ

Eₜ=−α*Sₜ+αLTEₜ+β*STEₜ

T represents the trend component of the time series. S represents the periodic (seasonal) component. E represents the event-based component. N represents the noise component. t represents the time.

The event component E includes terms LTE and STE. LTE represents the effects of a long-term event which lasts longer than one period and has an effect on the period component S. α is a control parameter which has a value in the range [0, 1]. STE represents the effect of a short-term event which is shorter than one period and thus only has a short time effect on the time series. β is a control parameter which represents the degree of the short-term event impact to the series.

In an embodiment:

Tₜ₊₁=median(∪ᵢ₌₀^{wt}TSₜ₋ᵢ)

Sₜ₊₁=median(∪ᵢ₌₀ⁿ∪_{j=-ws}^{j=ws}DeTₜₛ), where DeTₜₛ=TS−T

LTEₜ₊₁=median(∪ᵢ₌₀^{wlte}DeTₜₛ), where DeTₜₛ=TS−T

STEₜ₊₁=median(∪ᵢ₌₀^{wste}DeTSₜₛ), where DeTSₜₛ=TS−T−S

wt is a parameter representing the trend part window length (historical points length), ws represents the seasonal part window length, n is the period count of the time series, wlte represents the LTE part window length, and wste represents STE part window length.

The predicted value TSₜ₊₁ can be determined as follows:

TSₜ₊₁=Tₜ₊₁+(1−α)*Sₜ₊₁+α*LTEₜ₊₁+β*STEₜ₊₁

This solution sits on top (or as a second stage) of an existing time series prediction model. The described embodiments thus provide for:

1. Capturing previous data during the event
2. Adjusting that data during the previous events. Approaches for adjustment include:
a. Manual tuning parameters that adjust the data.
b. Automated calculated parameters that smooth the data.
   wt may be set to a period, where the period may be calculated by auto-correlation.
   wste may be set to a small length in the range [3, 10] because the effects of short-term events are continuous, and the state of each time point is affected by the state of the previous short period.
   wlte and α are two parameters that may be used to control the effect of the event on the period. This parameter can be calculated by using a simulated annealing algorithm.
   ws may be set in the range [3, 10], n is the period count of the historical series.
   β may be used to represent the impact of short events on time series.
   i. During a sudden event with historical training data:

$$histmedian = median ( {⋃}_{i = 0}^{wste} {histDeTS}_{ts} )$$

$$β = histvalue \text{/} histmedian$$

ii. During a sudden event without historical training data.

$$histmedian = median ( {⋃}_{i = 0}^{wste} {histDeTS}_{ts} )$$

$$β = {\sum }_{t = 0}^{wste} ( {histvalue}_{t} \text{/} {histmedian}_{t} )$$

histvalueₜ represents the historical point value of the same time in the event. histDeTS represents the residual series which deleted the seasonal and trend parts in the historical series.
   3. The algorithm for adapting the time series forecast during the event may then be applied to a new event.

The described embodiments allow for a more accurate prediction of a data point (e.g., a metric) starting at the time of a new event until the impact of the event is complete (for example, the impact of Daylight Savings Time might take a week or more). The described embodiments also allow for improved second stage models that leverage time series forecasting to improve user interfaces for providing such data. The improved accuracy can enable, for example, more targeted advertising for products during the course of the new event.

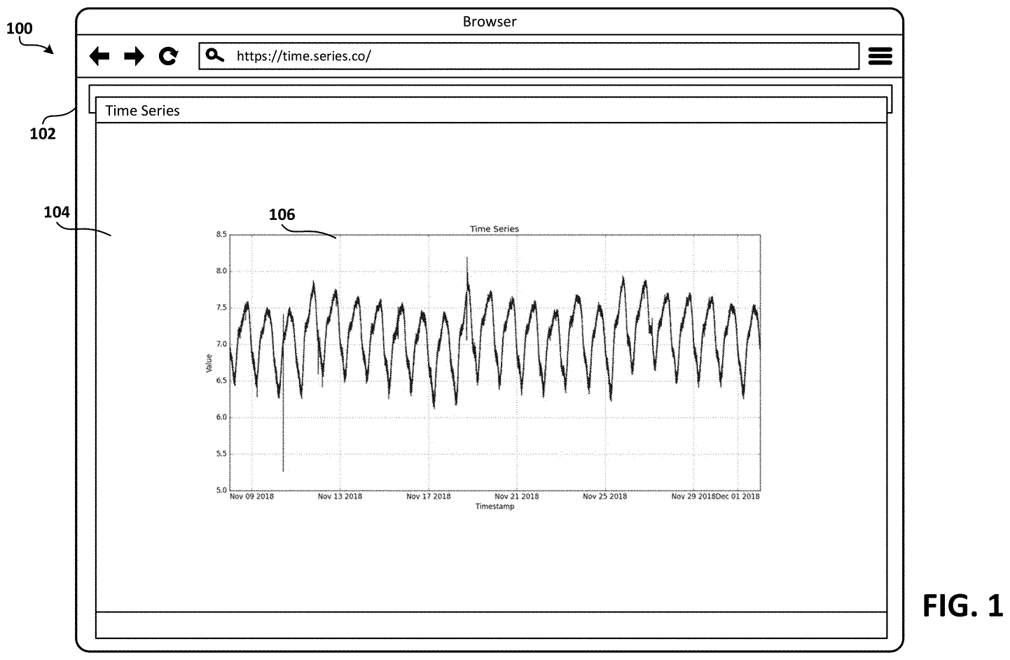

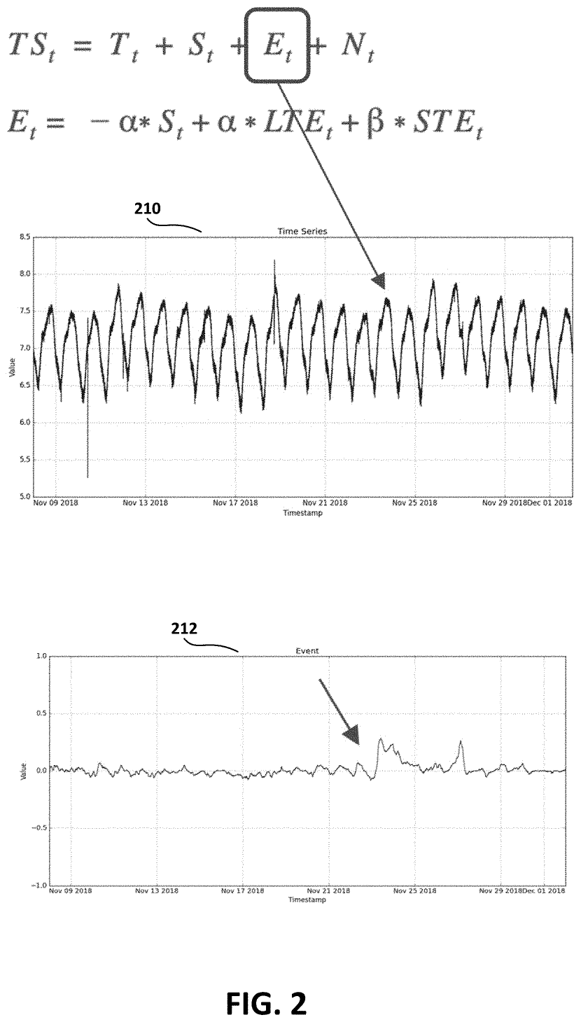

FIG. 1 illustrates one example of a display 100 that may be used to provide time series information to a user. The display 100 may render a browser window 102 that may be rendering an activity page 104. The activity page 104 may include information pertaining to a particular metric that is subject to a sudden event, and may include information such as the time series forecast 106. Therefore, it is important for this information to be as current as possible so that the information relied upon by the user is accurate. FIG. 2 illustrates the example time series 210 and event 212 corresponding to event Eₜ.

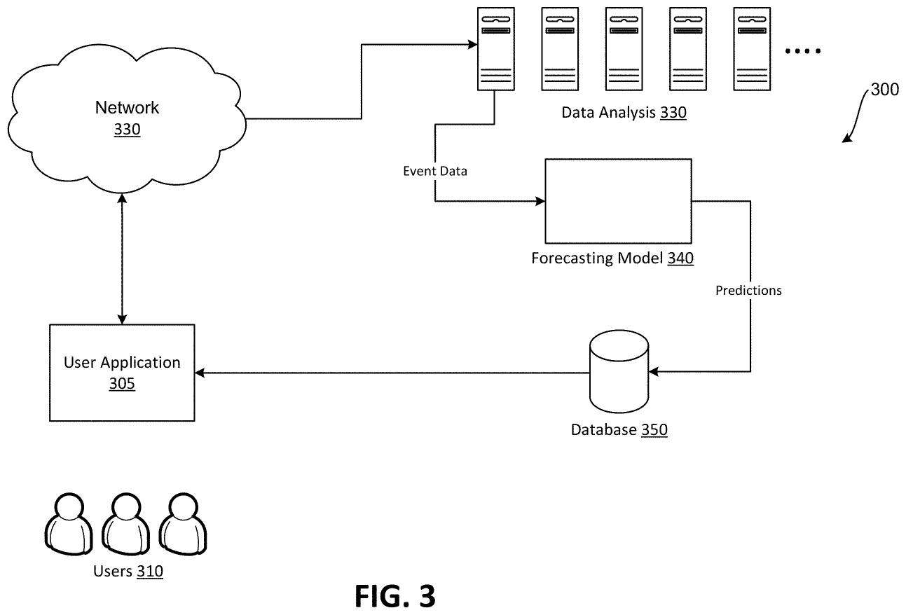

FIG. 3 is a computing system architecture diagram showing an overview of a system disclosed herein for an adaptive time series system, according to one embodiment disclosed herein. As shown in FIG. 3, an adaptive time series system 300 (which might also be referred to herein as a “time series system” or as a “prediction system”) may be configured to adapt a time series model based upon various event data (“event data”) generated by data analysis components 330 (which might be referred to individually as an “data analysis component 330” or collectively as the “data analysis components 330”).

The data analysis components 330 may, for example, include, but are not limited to, physical computing devices such as server computers or other types of hosts, associated hardware components (e.g. memory and mass storage devices), and networking components (e.g. routers, switches, and cables). The data analysis components 330 can also include software, such as operating systems, applications, and containers, network services, virtual components, such as virtual disks, virtual networks, and virtual machines. The database 350 can include data, such as a database, or a database shard (i.e. a partition of a database). The adaptive time series system 300 may be used to predict a metric that is used to update the user application 305 that provides the updated information to various users 310. In some configurations, a forecasting model 340 may be configured to modify a time series model. As shown in FIG. 3, the forecasting model 340 can generate predictions (which might be referred to herein simply as a “prediction”) based on data extracted from monitored information.

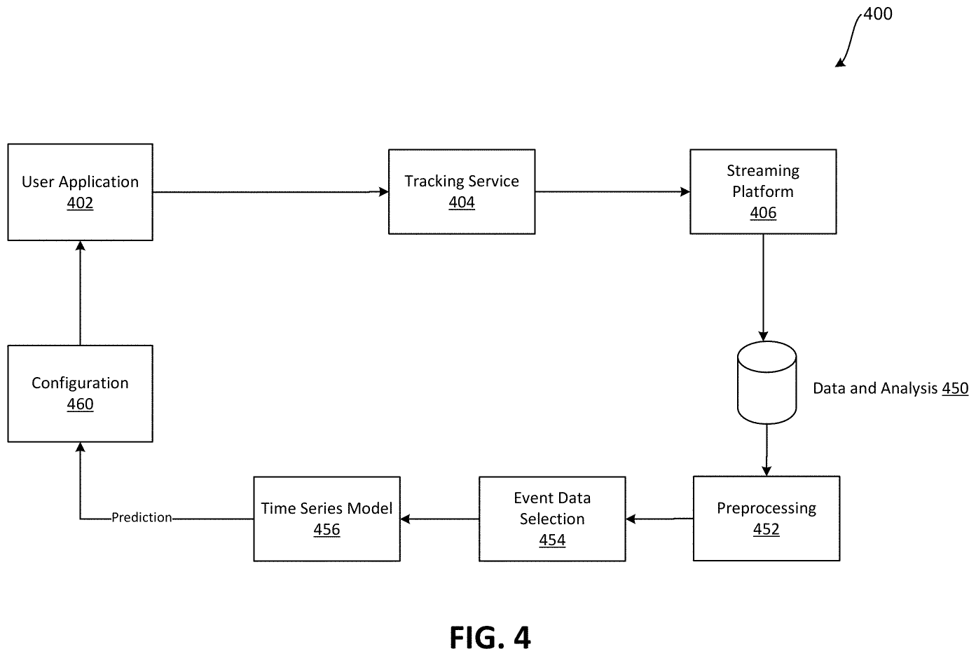

FIG. 4 is a computing system architecture diagram showing an overview of a system disclosed herein for an adaptive time series system, according to one embodiment. As shown in FIG. 4, an adaptive time series system 400 may be configured to predict metrics based upon tracking data generated by tracking service 404 and received from user application 402.

The tracking service 404 may send selected tracking data to a streaming platform 406. Data streams may be provided to a data storage component and analysis component 450. The data and analysis component 450 may provide data for a preprocessing component 452 that may be configured to process the stored data. The processed data may be provided to an event data selection component 454 that may be configured to select event data and properties. The processed data may be provided to time series model 456 that may use the data and properties to update the model based on the event data, generate a prediction, and send the prediction to configuration system 460.

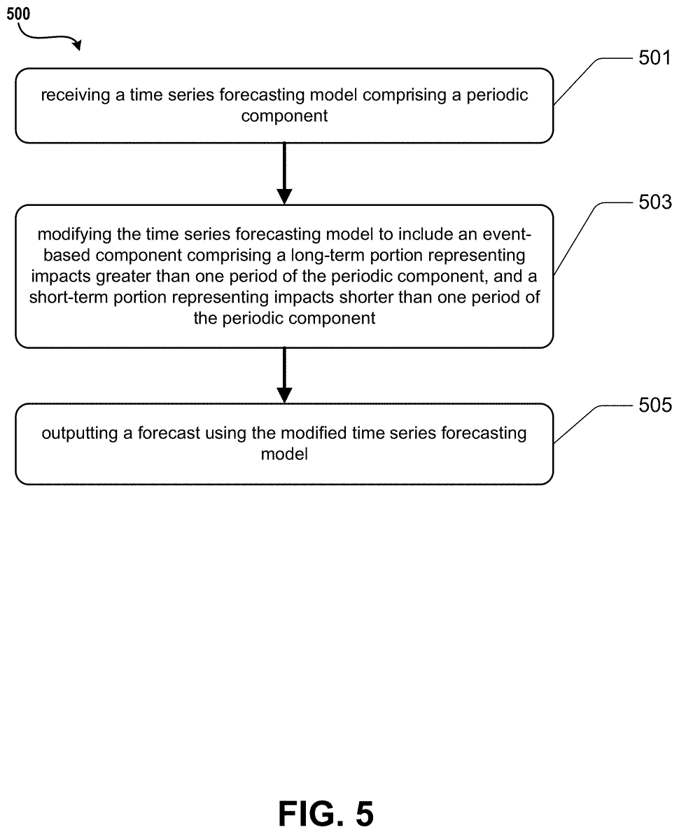

FIG. 5 is a diagram illustrating aspects of a routine 500 for implementing some of the techniques disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

The routine 500 begins at operation 501, which illustrates receiving a time series forecasting model comprising a periodic component.

The routine 500 then proceeds to operation 503, which illustrates modifying the time series forecasting model to include an event-based component comprising a long-term portion representing impacts greater than one period of the periodic component, and a short-term portion representing impacts shorter than one period of the periodic component.

Operation 505 illustrates outputting a forecast using the modified time series forecasting model.

In an embodiment, the time series forecasting model comprises a trend component and a noise component.

In an embodiment, the long-term portion and the short-term portion of the event-based component is different than the trend component and the periodic component.

In an embodiment, the method further comprises determining a first parameter indicative of a degree of the long-term portion.

In an embodiment, the method further comprises determining a second parameter indicative of a degree of the short-term portion.

In an embodiment, the method further comprises adjusting the event-based component based on the long-term and short-term portions.

In an embodiment, the method further comprises modifying the time series forecasting model using the event-based component.

In an embodiment, the time series forecasting model is configured to model a product sales forecast.

In an embodiment, the event-based component is representative of an anomalous external event.

In an embodiment, the time series forecasting model comprises a trend window length, a seasonal window length, a long-term window length, and a short-term window length.

In an embodiment, the first and second parameters are automatically adjusted by:

setting the trend window length to a time period using an autocorrelation;
setting the short-term window length within a predetermined range; and
adjusting the long-term window length and the first parameter using an annealing algorithm.

In an embodiment, outputting the forecast comprises:

receiving event data for a prior time period;
adjusting the first and second parameters; and
adjusting the received event data using the adjusted first and second parameters.

In an embodiment, the second parameter is determined as a ratio of a historical value and a historical median value.

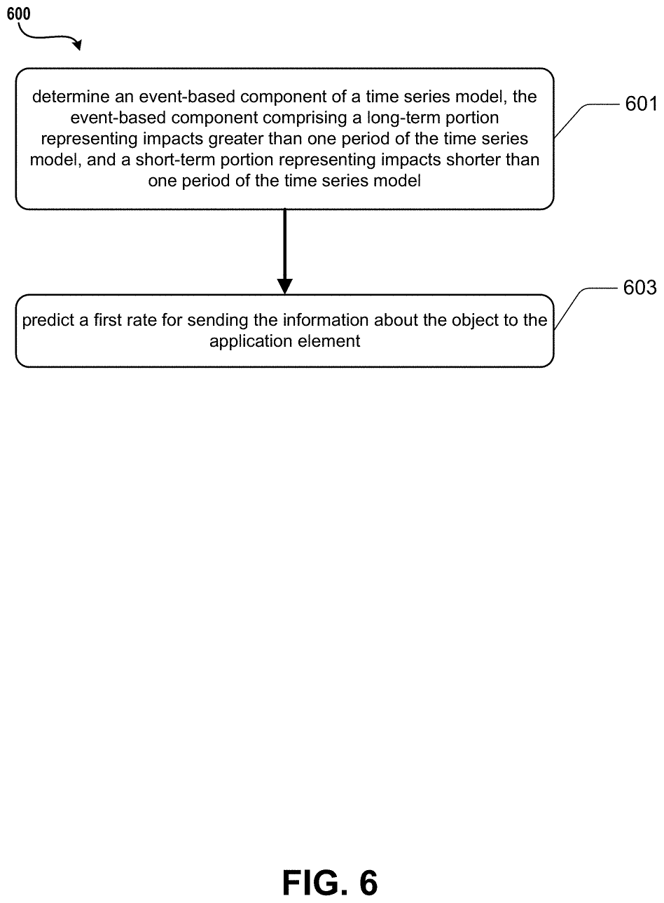

FIG. 6 is a diagram illustrating aspects of a routine 600 for implementing some of the techniques disclosed herein.

The routine 600 begins at operation 601, which illustrates determining an event-based component of a time series model, the event-based component comprising a long-term portion representing impacts greater than one period of the time series model, and a short-term portion representing impacts shorter than one period of the time series model.

In an embodiment, the routine further comprises determining a first parameter indicative of a degree of the long-term portion.

In an embodiment, the routine further comprises determining a second parameter indicative of a degree of the short-term portion.

In an embodiment, the routine further comprises adding the event-based component to the time series model, the long-term and short-term portions of the event-based component having been modified based on the first and second parameters.

In an embodiment, the time series model comprises a trend component and a seasonal component.

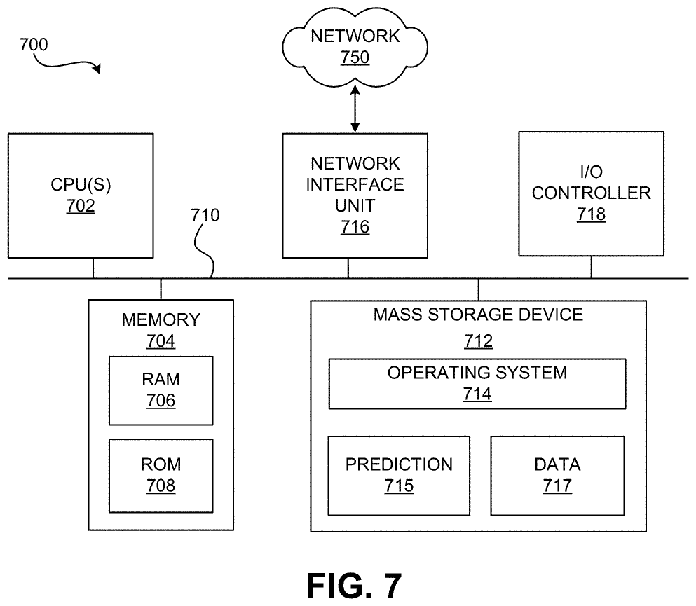

FIG. 7 shows an example computer architecture for a computer capable of providing the functionality described herein such as, for example, a computing device configured to implement the functionality described above with reference to FIGS. 1-6. Thus, the computer architecture 700 illustrated in FIG. 7 illustrates an architecture for a server computer or another type of computing device suitable for implementing the functionality described herein. The computer architecture 700 might be utilized to execute the various software components presented herein to implement the disclosed technologies.

The computer architecture 700 illustrated in FIG. 7 includes a central processing unit 702 (“CPU”), a system memory 704, including a random-access memory 706 (“RAM”) and a read-only memory (“ROM”) 708, and a system bus 710 that couples the memory 704 to the CPU 702. A firmware containing basic routines that help to transfer information between elements within the computer architecture 700, such as during startup, is stored in the ROM 708. The computer architecture 700 further includes a mass storage device 712 for storing an operating system 714, other data, and one or more executable programs, such as programs for implementing prediction 715 and storing data 717.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various implementations, the computer architecture 700 might operate in a networked environment using logical connections to remote computers through a network 750 and/or another network (not shown). A computing device implementing the computer architecture 700 might connect to the network 750 through a network interface unit 716 connected to the bus 710. It should be appreciated that the network interface unit 716 might also be utilized to connect to other types of networks and remote computer systems.

The computer architecture 700 might also include an input/output controller 718 for receiving and processing input from a number of other devices, including a keyboard, mouse, or electronic stylus (not shown in FIG. 7). Similarly, the input/output controller 718 might provide output to a display screen, a printer, or other type of output device (also not shown in FIG. 7). It should also be appreciated that via a connection to the network 750 through a network interface unit 716, the computing architecture might enable the product of the prefetch engine 108 to be distributed.

It should be appreciated that the software components described herein might, when loaded into the CPU 702 and executed, transform the CPU 702 and the overall computer architecture 700 from a general-purpose computing system into a special-purpose computing system customized to facilitate the functionality presented herein. The CPU 702 might be constructed from any number of transistors or other discrete circuit elements, which might individually or collectively assume any number of states. More specifically, the CPU 702 might operate as a finite-state machine, in response to executable instructions contained within the software modules disclosed herein. These computer-executable instructions might transform the CPU 702 by specifying how the CPU 702 transitions between states, thereby transforming the transistors or other discrete hardware elements constituting the CPU 702.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 might include other types of computing devices, including hand-held computers, embedded computer systems, personal digital assistants, and other types of computing devices known to those skilled in the art.

It is also contemplated that the computer architecture 700 might not include all of the components shown in FIG. 7, might include other components that are not explicitly shown in FIG. 7, or might utilize an architecture completely different than that shown in FIG. 7. For example, and without limitation, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

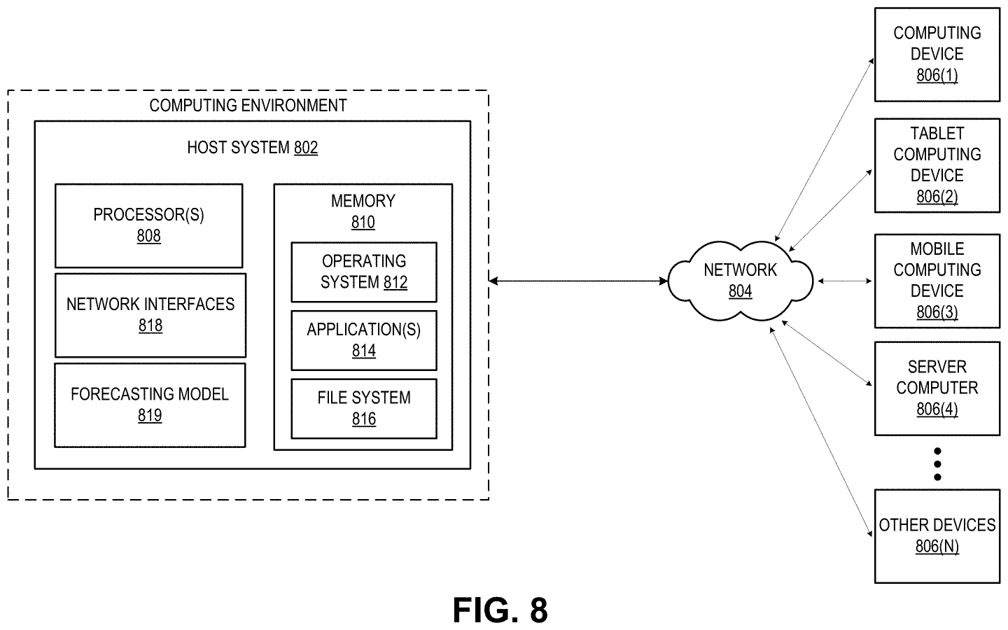

FIG. 8 illustrates an example computing environment capable of executing the techniques and processes described above with respect to FIGS. 1-7. In various examples, the computing environment comprises a host system 802. In various examples, the host system 802 operates on, in communication with, or as part of a network 804.

The network 804 can be or can include various access networks. For example, one or more client devices 806(1) . . . 806(N) can communicate with the host system 802 via the network 804 and/or other connections. The host system 802 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 802 can be provided by one or more servers that are executing as part of, or in communication with, the network 804. A server can host various services, virtual machines, portals, and/or other resources. For example, a can host or provide access to one or more portals, Web sites, and/or other information.

The host system 802 can include processor(s) 1208 memory 810. The memory 810 can comprise an operating system 812, application(s) 814, and/or a file system 816. Moreover, the memory 810 can comprise the storage unit(s) 82 described above with respect to FIGS. 1-7.

The processor(s) 808 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 810.

The memory 810 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 802 can communicate over the network 804 via network interfaces 818. The network interfaces 818 can include various types of network hardware and software for supporting communications between two or more devices. A forecasting model 819 may be implemented.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines are described herein as being implemented, at least in part, by an application, component, and/or circuit. Although the following illustration refers to the components of specified figures, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

In closing, although the various technologies presented herein have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method of implementing a time series forecasting model, the method comprising:
receiving the time series forecasting model comprising a periodic component;
determining a long-term event-based component representing single-event impacts that last for greater than one period of the periodic component;
determining a short-term event-based component representing single-event impacts that last for less than one period of the periodic component;
modifying the time series forecasting model to include the long-term event-based component, and the short-term event-based component; and
outputting a forecast using the modified time series forecasting model.

2. The method of claim 1, wherein the time series forecasting model comprises a trend component and a noise component.

3. The method of claim 2, wherein the long-term event-based component and the short-term event-based component are different than the trend component and the periodic component.

4. The method of claim 1, further comprising determining a first parameter indicative of a degree of the long-term event-based component.

5. The method of claim 4, further comprising determining a second parameter indicative of a degree of the short-term event-based component.

6. The method of claim 5, further comprising adjusting the long-term event-based component and the short-term event-based component based on the first parameter and the second parameter.

7. The method of claim 6, further comprising modifying the time series forecasting model using the long-term event-based component and the short-term event-based component.

8. The method of claim 1, wherein the time series forecasting model is configured to output a product sales forecast.

9. The method of claim 1, wherein the long-term event-based component and the short-term event-based component are representative of an anomalous external event.

10. The method of claim 5, wherein the time series forecasting model comprises a trend window length, a seasonal window length, a long-term window length, and a short-term window length.

11. The method of claim 10, wherein the first parameter and the second parameter are automatically adjusted by:
setting the trend window length to a time period using an autocorrelation;
setting the short-term window length within a predetermined range; and
adjusting the long-term window length and the first parameter using an annealing algorithm.

12. The method of claim 5, wherein outputting the forecast comprises:
receiving event data for a prior time period;
adjusting the first parameter and the second parameter; and
adjusting the received event data using the adjusted first parameter and the second parameter.

13. The method of claim 5, wherein the second parameter is determined as a ratio of a historical value and a historical median value.

14. A computing system, comprising:
a processor; and
a computer-readable storage medium having computer-executable instructions stored thereupon which, when executed by the processor, cause the processor to:
determine a long-term event-based component of a time series model representing single-event impacts that last for greater than one period of the time series model;
determine a short-term event-based component of the time series model representing single-event impacts shorter than one period of the time series model; and
generate an output using the time series model.

15. The computing system of claim 14, further comprising computer-executable instructions stored thereupon which, when executed by the processor, cause the processor to determine a first parameter indicative of a degree of the long-term event-based component.

16. The computing system of claim 15, further comprising computer-executable instructions stored thereupon which, when executed by the processor, cause the processor to determine a second parameter indicative of a degree of the short-term event-based component.

17. The computing system of claim 16, further comprising computer-executable instructions stored thereupon which, when executed by the processor, cause the processor to add the long-term event-based component and the short-term event-based component to the time series model, the long-term event-based component and the short-term event-based component having been modified based on the first parameter and the second parameter.

18. (canceled)

19. A computer-readable storage medium having computer-executable instructions stored thereupon which, when executed by a computing device, cause the computing device to:
determine a long-term event-based component of a time series model representing single-event impacts that last for greater than one period of the time series model;
determine a short-term event-based component of the time series model representing single-event impacts shorter than one period of the time series model; and
generate an output using the time series model.

20. The computer-readable storage medium of claim 19, wherein the time series model comprises a trend component and a seasonal component, further comprising computer-executable instructions stored thereupon which, when executed by the computing device, cause the computing device to:
determine a first parameter indicative of a degree of the long-term event-based component;
determine a second parameter indicative of a degree of the short-term event-based component; and
add the long-term event-based component and the short-term event-based component to the time series model, the long-term event-based component and the short-term event-based component having been modified based on the first parameter and the second parameter.

21. The method of claim 1, wherein outputting the forecast using the modified time series forecasting model comprises:
receiving event data indicating that an event of the long-term event-based component and the short-term event-based component has occurred;
updating the modified time series forecasting model based on the event data and the long-term event-based component and the short-term event-based component; and
generating the forecast using the updated time series forecasting model.
